(19) United States
(12) Patent Application Publication
(10) Pub. No.: US 2026/0086340 A1
(43) Pub. Date: Mar. 26, 2026

(54) SpiralVortex Superresolution Localization Imaging

(71) Applicant: University of Denver, Denver, CO (US)

(72) Inventors: Mark Siemens, Denver, CO (US); Emily Gibson, Denver, CO (US); Diego Restrepo, Denver, CO (US); Juliet Gopinath, Boulder, CO (US)

(21) Appl. No.: 19/333,004

(22) Filed: Sep. 18, 2025

Related U.S. Application Data
(60) Provisional application No. 63/697,020, filed on Sep. 20, 2024.

(51) Int. Cl. G02B 21/00; G02B 21/18

(52) U.S. Cl. CPC G02B 21/0072; G02B 21/0016; G02B 21/0076; G02B 21/008; G02B 21/18

(57) ABSTRACT

A method and system for locating a position of a target within an object is disclosed. A method comprises imparting a beam of light on to an object to induce fluorescence from a target;
creating an intensity null in the beam, moving the intensity null within the beam, obtaining fluorescence data from the target as a function of a location of the intensity null, and determining the location of the target based upon the data.

### CLAIM OF PRIORITY UNDER 35 U.S.C. § 119

The present application for patent claims priority to Provisional Application No. 63/697,020 entitled “SpiralVortex Superresolution Localization Imaging” filed Sep. 20, 2024, and assigned to the assignee hereof and hereby expressly incorporated by reference herein.

### SPONSORED RESEARCH AND DEVELOPMENT

This invention was made with government support under contract numbers 1919541 and 1919361 awarded by National Science Foundation. The government has certain rights in the invention.

### FIELD

The present invention relates to fluorescence measurements. In particular, but not by way of limitation, the present invention relates to highly precise localization of an emitter signal with superresolution.

### BACKGROUND

Superresolution fluorescence microscopy is a powerful tool in biology, enabling the location of as small as a single emitter (e.g., a tagged neuron or protein in a mouse brain) with superresolution by scanning an excitation beam to determine a centroid of measured fluorescence at a resolution of less than a wavelength of light. For example, R. Schmidt, et al. (“MINFLUX nanometer-scale 3D imaging and microsecond-range tracking on a common fluorescence microscope,” Nature Communications, vol. 12, no. 1, p. 1478, 2021) and Balzarotti, et al. (“Nanometer resolution imaging and tracking of fluorescent molecules with minimal photon fluxes,” Science, vol. 355, no. 6325, pp. 606-612, 2017) describe the MINFLUX technique, which allows superresolution microscopy at approximately one nanometer precision, resolving molecules 6 nanometers apart. The MINFLUX approach requires fewer excitation photons compared to previous methods and so is especially suited to superresolution localization of biological features where high flux could damage tissue. However, MINFLUX is not well-suited for use in imaging deep within living tissue because inhomogeneous tissue strongly absorbs the excitation light and prevents the excitation beam from being precisely steered to multiple locations to acquire the fluorescent signals required for MINFLUX to work accurately.

Thus, there is a need for an improved approach to enable superresolution localization of extremely small emitter signals within live tissue.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

Some aspects may be characterized as a method for locating a position of a target within an object where the method comprises imparting a beam of light on to an object to induce fluorescence from a target, creating an intensity null in the beam, moving the intensity null within the beam, obtaining fluorescence data from the target as a function of a location of the intensity null, and determining the location of the target based upon the data.

The intensity null may be moved in a pattern within the beam to create a specific fluorescence response from the target over the path of the intensity null. The intensity null may be moved along a spiral path within the beam.

Other aspects may be characterized as a system for locating a position of a target within an object. The system may comprise a light source to impart a beam of light on to an object to induce fluorescence from a target, a beam shaper configured to produce a moving intensity null within the beam, a detector configured to detect fluorescence from a target within an object, processing logic configured to locate the target within the object based upon the detected fluorescence and the location of the intensity null.

The light source may comprise a laser configured to impart the beam of light as coherent light, but some variations may utilize an incoherent light source.

Some aspects may be characterized as a superresolution localization imaging method comprising a stable excitation beam with an intensity null that is moved stepwise in a spiral pattern, fluorescence from a target object is measured as a function of the motion of the intensity nulls without scanning the excitation beam. In embodiments, the excitation beam does not move and the signal is acquired as a function of the intensity null moving out from the beam center in a stepwise spiral pattern. In certain embodiments, a spiral pattern of the intensity null is effectuated by a constant radial step rate Δr and constant azimuthal step rate Δφ.

Aspects may also be characterized as a superresolution localization imaging system comprising a light source configured for providing a stable excitation beam with a spiral pattern of an intensity null, and a sensor configured for measuring a fluorescence from a target in an object as a function of the motion of the intensity null.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF DRAWING FIGURES

FIG. 1 is a block diagram depicting an example system;

FIG. 2 depicts four examples of a stationary beam while an intensity null moves within the stationary beam;

FIG. 3 shows four examples of a stationary beam an intensity null does not move within the stationary beam;

FIG. 4 shows an example an intensity null moving in a spiral pattern;

FIG. 5 shows examples of an intensity null moving at different steps;

FIG. 6 shows examples of measurements for two target emitters depicted in FIG. 4;

FIG. 7 shows results for two spiral scans for a same target emitter location;

FIG. 8 shows a median localization accuracy of a realization of quantized detection for the same target emitter location as in FIG. 7;

FIG. 9 is a graph showing the median localization error for 1000 different random emitter locations;

FIG. 10 is a diagram depicting an example system;

FIG. 11A is a diagram depicting a schematic setup for another example system;

FIG. 11B is a diagram depicting a technical setup for the system depicted in FIG. 11A;

FIG. 12 depicts an example of a microscope; and

FIG. 13 shows an example of information for in-beam scanning localization associated with the microscope of FIG. 12.

### DETAILED DESCRIPTION

For simplicity and clarity of illustration, the drawing figures illustrate the general manner of construction, and descriptions and details of well-known features and techniques may be omitted to avoid unnecessarily obscuring the embodiments detailed herein. Additionally, elements in the drawing figures are not necessarily drawn to scale. For example, the dimensions of some of the elements in the figures may be exaggerated relative to other elements to help improve understanding of the described embodiments. The same reference numerals in different figures denote the same elements. As used in the specification and in the claims, the singular form of ‘a,’ ‘an,’ and ‘the’ include plural referents unless the context clearly dictates otherwise.

The word “exemplary” is used herein to mean “serving as an example, instance, or illustration.” Any embodiment described herein as “exemplary” is not necessarily to be construed as preferred or advantageous over other embodiments. In the following detailed description, references are made to the accompanying drawings that form a part hereof, and in which are shown by way of illustrations or specific examples. These aspects may be combined, other aspects may be utilized, and structural changes may be made without departing from the present disclosure. Example aspects may be practiced as methods, systems, or apparatuses. The following detailed description is therefore not to be taken in a limiting sense, and the scope of the present disclosure is defined by the appended claims and their equivalents.

As used herein, the term “intensity null” (or alternatively “dark spot” or “vortex”) generally refers to a region of lower light intensity within a beam of light. An “intensity null” of a beam need not necessarily be exactly zero intensity, but may be near zero, or otherwise a relatively small proportion of the beam's peak intensity. In various embodiments, the “intensity null” of the beam may be, for example, approximately one percent (or smaller) of peak intensity, approximately 0.5 percent (or smaller) of peak intensity, approximately 0.1% (or smaller) of peak intensity, approximately 0.01% (or smaller) of peak intensity, or approximately 0.001% (or smaller) of peak intensity, and so forth.

Some techniques described herein are characterized as SpiralVortex localization techniques, but it should be recognized that aspects disclosed herein are directed more generally to moving an intensity null in a pattern within a beam that may or may not be a spiral pattern.

As used herein a “target” is generally any physical construct that is a subject of localization. In other words, in many use cases, determining a location of the target is a goal. As examples, a “target” may be a single molecule but need not be a single molecule, and instead may be, for example, a larger macromolecular assembly. Dimensions of targets may be below the diffraction limit of a microscope, such as below 200 nanometers. As used herein, it should be understood that references to biological constructs being located or tracked may encompass not only single molecules but also molecular assemblies, unless stated otherwise. Specific examples of targets are discussed further herein.

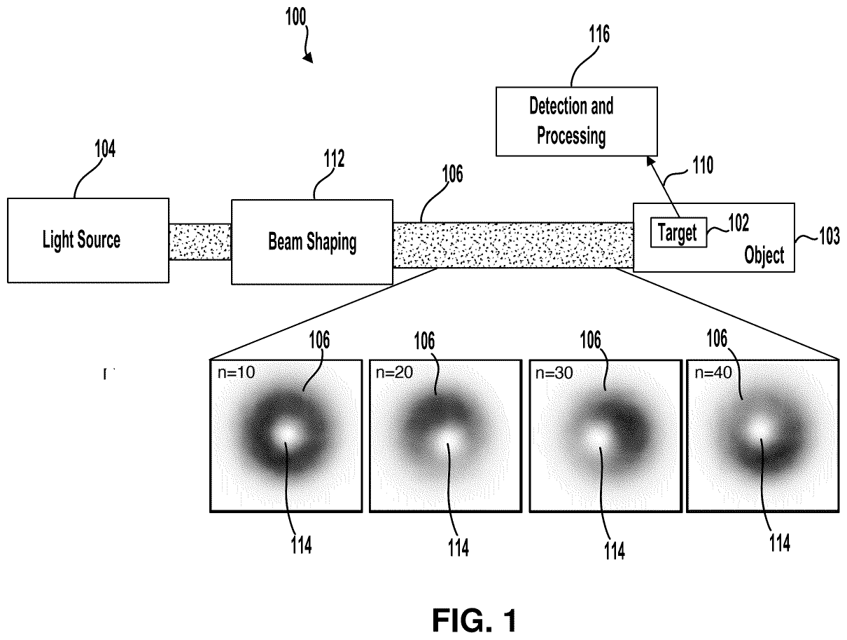

Referring first to FIG. 1, shown is a block diagram of a system 100 for locating a position of a target 102 within an object 103. A light source 104 is configured to impart a beam 106 of light on to the object 103 to induce fluorescence 110 from the target 102. The system also includes beam shaping 112 that represents components that are configured to create an intensity null 114 in the beam 106 and move the intensity null 114 within the beam 106.

In many variations of the system 100, the beam 106 may have a cross section that is generally circular, but this is optional, and in other variations cross section of the beam may have a shape that is not circular. Similarly, a cross section of the intensity null 114 may have a generally circular shape, but this is not required.

Shown in FIG. 1 are four example locations for the intensity null 114 within the beam 106. The depicted example locations are intended merely to show that, in contrast to other superresolution techniques, the intensity null 114 is moved within the beam 106.

Also shown are detection and processing components 116 that are generally configured to detect the fluorescence 110 and obtain fluorescence data from the target 102 as a function of a location of the intensity null 114 to determine the location of the target 102 based upon the data.

As discussed further herein, the intensity null 114 may be moved in a defined pattern to create a specific fluorescence response from the target 102 over the path of the intensity null 114. In many variations, the pattern may be a spiral pattern as discussed further herein.

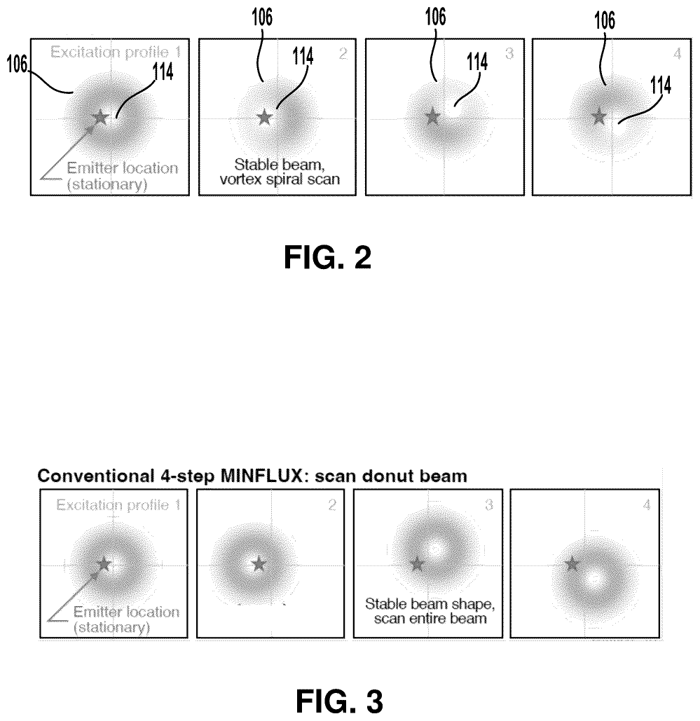

Referring to FIG. 2, shown are four examples depicting a stationary beam 106 while the intensity null 114 moves relative to an emitter location. FIG. 2 further demonstrates movement of the intensity null 114 within a beam 106, which stands in contrast to moving an entire beam as shown FIG. 3.

More specifically, in the MINFLUX approach shown in FIG. 3, an intensity null remains in a center of a beam of light while the entire beam of light is moved. The approach depicted in FIG. 3 to superresolution localization imaging involves the scanning of an excitation beam across a target area of a sample in order to excite and then detect the resulting fluorescence from an emitter. But when the sample is living tissue, the variations in the different layers of tissue, the presence of biological structures, and other complications result in optical aberrations, absorption, and scattering, which can steer the excitation beams in unknown ways such that the actual excitation spot is not what was programmed. Another limitation is that MINFLUX and other superresolution techniques use single photon excitation of fluorescence, which means that the excitation light is in the visible part of the spectrum where tissue is strongly absorbing and scattering. Additionally, repeated scanning of the excitation beam across the emitter, such as with the MINFLUX approach, may lead to photobleaching and phototoxicity in biological tissue, further reducing the effectiveness of these existing methods.

In contrast, in the approach disclosed herein the excitation beam 106 is kept stable while fluorescence 110 may be measured a function of the intensity null 114 that is moved relative to a fixed position of the excitation beam. For example, the intensity null 114 may be moved relative to a center of the excitation beam 106. Measurements of the fluorescence 110 may be processed computationally to extract the location of the target 102 emitter with superresolution.

Aspects of the techniques described with reference to FIGS. 1 and 2 (and additional variations disclosed herein) enable imaging of essential nanometer-scale structures, deep (e.g., hundreds of microns) below the brain's surface in living organisms and through nonuniform structures. Approaches described herein can achieve single-molecule localization microscopy with superresolution at imaging depths ≥100 μm, which is currently inaccessible by existing techniques.

Aspects disclosed herein also involve the combination of two-photon microscopy with a structured illumination of the sample, using an intensity null that moves in a pattern, such as a spiral, within a stationary beam, resulting in significant improvement in the accuracy in locating a target 102 (e.g., a fluorescent emitter) when contrasted with traditional techniques such as MINFLUX—especially for measurements deep in tissue. It is noted that the combination with two-photon microscopy is of interest for deep tissue probing as the longer wavelengths used in two photon excitation generally experience less absorption and scattering.

In some applications, the beam 106 may be used to illuminate a specific brain region in a behaving animal, such as via an optical fiber or with the animal's head fixed in a microscope. The intensity null 114 of the beam 106 may be rapidly modulated spatially while the fluorescence 110 is collected and analyzed, to determine the locations of targets 102 (e.g., fluorescence emitter) s with superresolution.

Such an approach is useful for biological applications including, for example, two-photon imaging (2P) in cortical layers ⅔ at ˜250 microns below the brain surface to visualize organization of sodium channels at nodes of Ranvier. A target 102 such as an isolated fluorophore tagged to an individual sodium channel may be localized with approaches disclosed herein by moving the intensity null within the beam, and the process may be repeated to build up an image of multiple channels. Specific determination of sodium channel organization may be performed with the enhanced resolution of this approach, which is not possible with standard multiphoton techniques. As a result, the channel organization at the nodes of Ranvier may be imaged at different time points during motor learning. Additional applications of the technology may include studying synaptic protein organization in active zones in vivo and changes associated with learning.

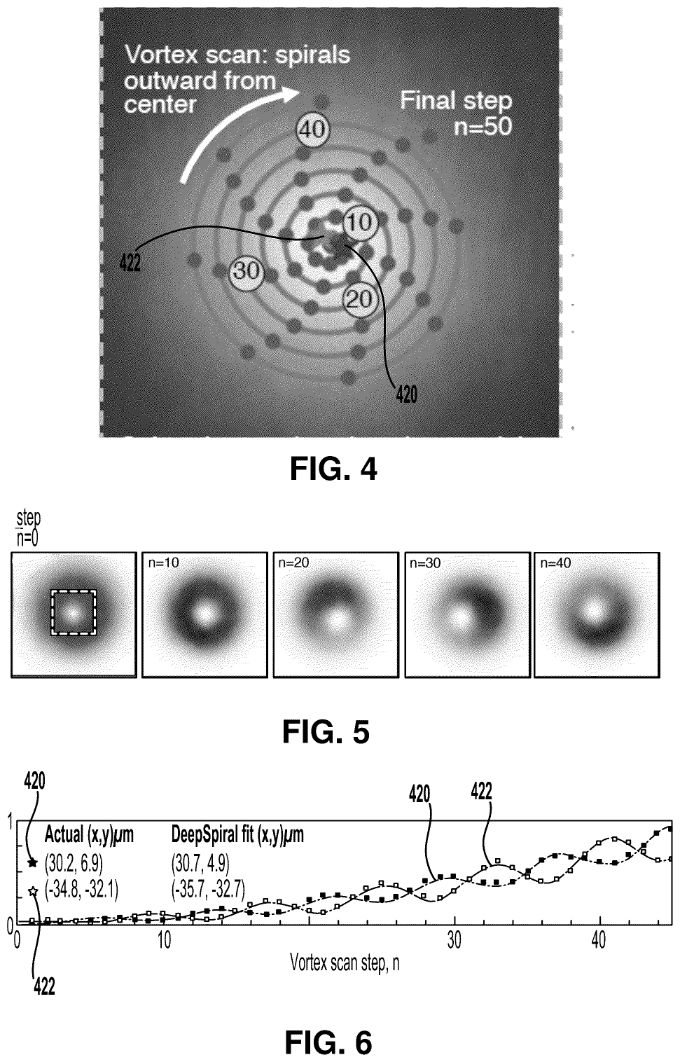

As shown in FIG. 4, the intensity null 114 may be moved in a spiral pattern with constant azimuthal step rate Δφ and radial step rate Δr starting from the beam center as shown in shown in FIG. 4. FIG. 5 shows example laser modes with the intensity null at various spiral steps. FIG. 6 depicts example measurements and fits for the locations indicated by locations 420 and 422 of targets in FIG. 4 demonstrating accuracy and demonstrating a “position fingerprint” of the spiral vortex scan.

For a target 102 emitter at polar coordinates (R, Φ) from beam center, fluorescence as a function of spiral vortex step n is:

$${I}_{n} ( R , ϕ ) = A ( {R}^{2} + {( {Δ}_{r} n )}^{2} - 2 R {Δ}_{r} n cos ( ϕ - {Δ}_{φ} n ) . \qquad ( 1 )$$

This modulated oscillatory fluorescence signal is unique to a particular emitter location, and the location can be determined by fitting spiral scan fluorescence measurements. Specifically, Eq. 1 can be fit to the experimental data with fit parameters A, R, and Φ. The clear oscillations enable strong fitting for accurate location and noise rejection, analogous to how a lock-in amplifier removes noise by integrating oscillatory signals. In this way, the emitter's polar position (R, Φ), relative to the beam center, can be determined with superresolution accuracy that is better, and with lower exposure power, than a similar measurement with a spirally-moving Gaussian beam.

To test this concept, a computational model of a point emitter excited by a beam with an intensity null spiraling in a Gaussian beam of 150 nm radius was implemented. In the model, 2.5% efficiency was assumed between excitation and detected photons to account for detector efficiency, finite numerical aperture of the collection optics, back-reflections in optics, and absorption losses. Quantized detection was implemented with weighted probabilities, and multiple detection events at each intensity null step were used to build a meaningful scan. Then Equation 1 was fit to the scan data and the error in localization accuracy was determined. 1000 realizations of random emitter positions were performed within half of the beam radius, and the median of the error in the position was recorded. After testing different values for scan parameters, the following parameter values were selected: Δᵣ=1.5 nm, Δ_{φ}=0.8 radians, and N=50.

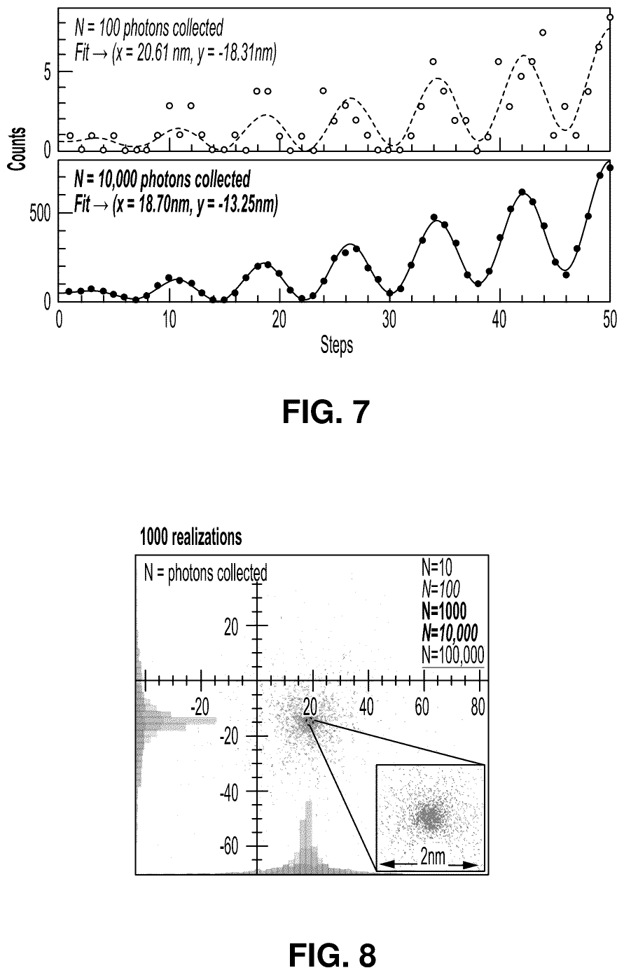

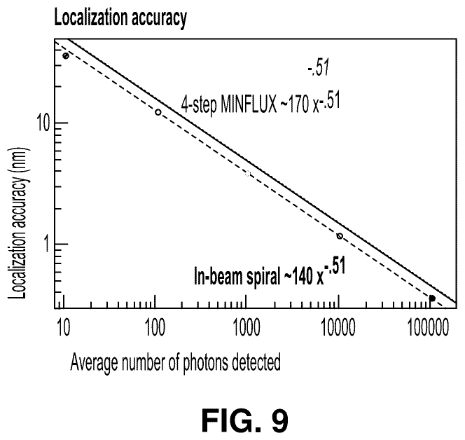

FIG. 7 shows the results for two spiral scans for the same emitter location, with identical scan settings except for number of averages that determines the total number of photons collected N. The fit yields quite accurate results even with the significant noise in the N=100 data. In FIG. 8, each dot shows the median localization accuracy of a realization of quantized detection for the same emitter location as in FIG. 7. FIG. 9 shows the median localization error for 1000 different random emitter locations. The broken line shows the best fit of the data. Also shown are the results of the two different localization schemes implemented with the same quantum efficiency and shot noise framework fit to the same function. The solid line shows results from the usual 4-step MINFLUX obtained through four measurements and a minimization algorithm.

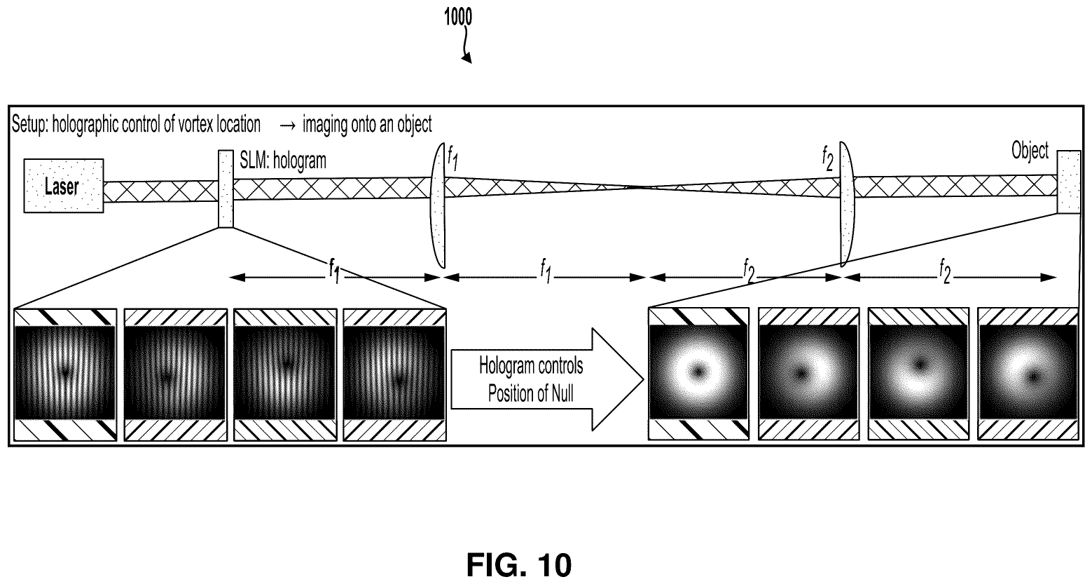

Referring next to FIG. 10, shown is a system 1000, which is a variation of the system 100. As shown, beam shaping 112 may be implemented with a spatial light modulator (SLM) where the intensity null 114 may be moved by updating holograms displayed on the SLM. The system 1000 may be suitable for applications that do not require high readout speeds because the system 1000 may provide an update rate of approximately 100 Hz.

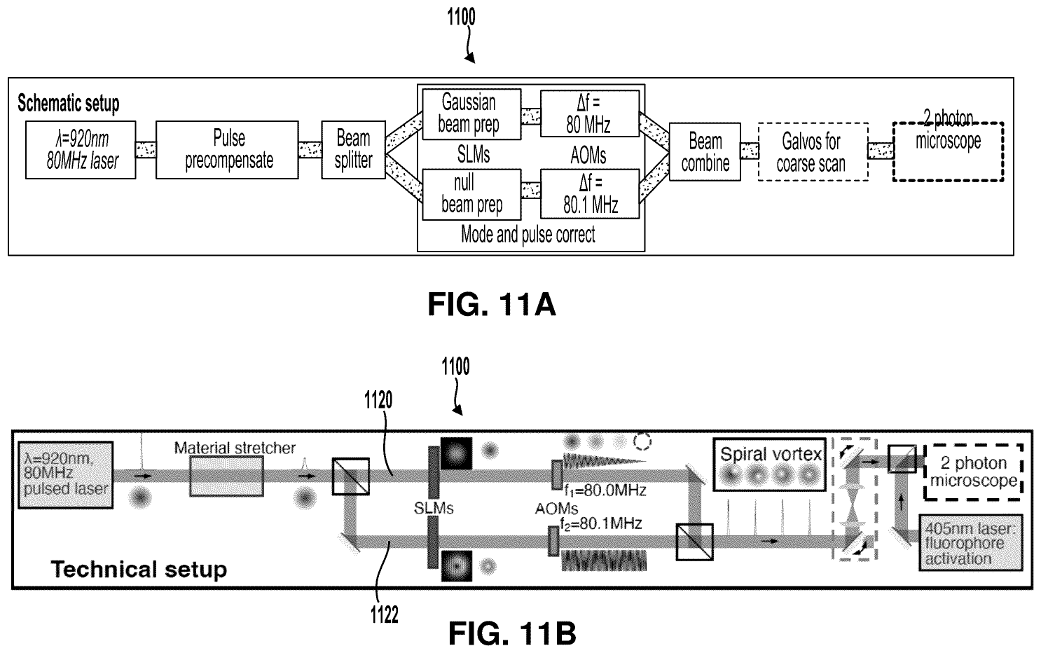

Referring next to FIGS. 11A and 11B, shown are schematic and technical setup representations, respectively, of a system 1100 that may provide higher repetition rates. As shown, the excitation light source 104 in this embodiment comprises a laser (e.g., a pulsed titanium-sapphire laser), and its beam may be split into two paths (e.g., with a 50/50 beam splitter), and each path may be controlled by an SLM with a diffractive hologram that is static (e.g., not changing with time) to sculpt each beam.

A static Gaussian mode may be generated in a first beam path and a static Laguerre Gaussian donut mode may be generated in a second beam path. The SLM may be followed by a 4f imaging system and an acousto-optic modulator (AOM) for fast amplitude and phase modulation.

As shown, there is a first spatial light modulator and a first acousto-optic modulator positioned in the first beam path 1120, and the first acousto-optic modulator is configured to modulate an intensity and shift the frequency of light in the first beam path 1120. This intensity modulation rate sets the radial scan rate of the resulting spiraling vortex. There is also a second spatial light modulator and a second acousto-optic modulator positioned in the second beam path 1122. In this system, the second spatial light modulator is configured to produce the intensity null in the second beam (e.g., form the second beam in the shape of a donut), and the second acousto-optic modulator is configured to shift a frequency of the light in the second beam. As shown, a combiner is configured to combine the first and second beam to produce the moving intensity null within the beam.

This combination of SLMs and AOMs exhibits an advantage of correcting temporal and spatial chirp from diffractive elements, which is frequently a major limitation of diffractive holography with pulsed lasers. On recombination, the two modes interfere such that AOM mediated amplitude and phase provide pulse-to-pulse control over the location of the intensity null in the combined beam.

As shown, the resulting mode has the desired intensity null scanning pattern for a beam-stable SpiralVortex in each sequence of 800 pulses (4 pulses shown for clarity). The beam is split again with a polarizing beamsplitter, and each is run through a separate x-y galvanometer scan path for separate coarse scanning of both imaging and reference beams.

Beneficially, the system 1100 enables high resolution molecular tracking in scattering tissue involve several innovations including: (1) spatial and acousto-optic phase modulators to implement an excitation scheme for fast (up to 100 kHz possible) beam-stable null scanning; (2) superresolution localization with two-photon excitation at 920 nm for imaging through scattering media; (3) optimal beam shaping for aberration correction; and (4) reference bead motion correction to achieve sub-50 nm resolution. The system may be optimized, for example, for fast imaging at a localization rate of 100 kHz, enabling fast single-molecule tracking at depth and in vivo.

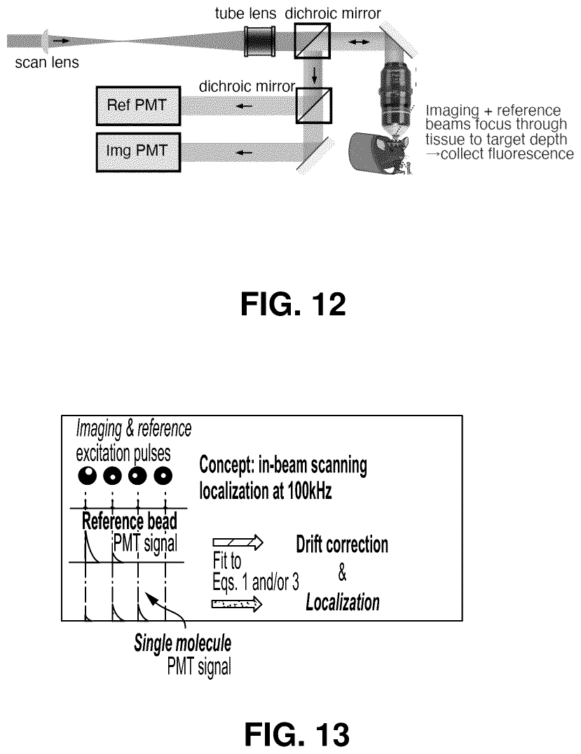

In embodiments, the in-beam nullity scanning may be utilized with a two-photon microscope shown in FIG. 12 with a pulsed laser and time-correlated photon counting detection. In some embodiments, the system of FIGS. 11A and 11B may be integrated with a multi-photon microscope. As shown in FIGS. 12 and 13, the microscope may split the structured beam into two separate scan paths where one path (imaging path) may be used for localization and tracking of the structures of interest, while the other, a reference path, may be used for localizing on a stationary bright fluorescent bead with a different emission wavelength (GATTAquant). Additional configurations and variations are contemplated and are considered to be a part of the present disclosure.

Referring back to FIGS. 11A and 11B, in operation, the azimuthal scanning rate Δφ between pulses may be controlled by operating the AOMs at slightly different frequencies:

$$Δ {f}_{AOMs} = {f}_{AOM 1} - {f}_{AOM 2} \to {Δ}_{φ} = Δ {f}_{AOMs} / {f}_{rep} \qquad [ Eq . 2 ]$$

where fᵣₑₚ is the repetition rate of the pulsed laser. For example, a 1000 step scan with a laser repetition rate of frep=80 MHz could have fAOM1=50 MHz and fAOM2=55 MHz, resulting in Δφ=0.0625 radians/step. The radial scan rate Δᵣ is a function of a diameter of the excitation beam, a relative intensity of the beams in the first beam path 1120 and the second beam path 1122, a repetition rate of the laser, and the repetition rate of the intensity modulation in the first beam path 1120. The intensity modulation of the beam in the first beam path 1120 may be, for example, established by a sawtooth function to obtain a spiraling intensity null.

The combined beam may then be sent into a galvanometer-scanned 2-photon microscope. Coarse scanning may be performed with galvos, followed by the SpiralVortex technique implemented at regions of interest. The combined beams may be focused through tissue with a lens or microscope objective to the desired target depth. The target beam path also includes a dichroic mirror that may combine a photo-activation laser with a different wavelength. The fluorescence from the molecule being tracked is separated from the reference bead by emission color, and fitting to Eq. 3 (which is simply a different form of Eq. 1) allows superresolution localization of each—the reference measures the lateral drift that can be used to correct the primary localization measurement.

$$A \{ {r}_{o}^{2} + {( {Δ}_{r} n )}^{2} - 2 {r}_{o} {Δ}_{r} n cos ( {ϕ}_{o} - {Δ}_{ϕ} n ) \} \qquad [ Eq . 3 ]$$

In other words, rather than scanning the excitation beam itself, the SpiralVortex approach keeps the excitation beam stationary and varies the excitation beam profile by the spiraling of a dark spot within the excitation beam. In this way, the stable excitation beam used in the SpiralVortex approach enables superresolution localization measurements in deep tissue, such as for resolving sub-diffraction limited features and protein dynamics. In fact, if two-photon excitation is used, the SpiralVortex approach enables the superresolution localization at depths up to approximately 300 microns within the brain. Further, the SpiralVortex approach may permit visualization of the real-time rearrangement of individual molecules such as neurotransmitter receptors, ion channels, and adhesion molecules at cellular structures and interactions in the intact, living brain. For instance, the temporal resolution may be enhanced by using an 80 MHz rate for the laser repetition and individual fluorescence measurement, with approximately 800 to 1000 individual measurements made for averaging and scanning in enabling the computational fitting and localization processes. The enhanced temporal (>100 kHz) and spatial (˜10 nm) resolutions will facilitate the connection of subcellular structure and molecular dynamics, such as ion channel localization at synapses or nodes of Ranvier, to functional changes in neural circuits that underlie learning.

Compared to the MINFLUX approach described above, the in-beam null scanning approach described herein provides superior localization resolution per excitation photon, thus reducing the risk of photobleaching while enabling measurements at greater depth even within inhomogeneous tissue. In addition, the techniques disclosed herein do not rely on a camera and can therefore be used in scattering tissue. Use of multiphoton excitation allows deeper penetration depth to reach brain structures in living organisms. This characteristic may enable molecular localization and tracking in living tissue at depths >100 μm to observe complex dynamics in vivo and, in particular, allow novel studies of these dynamics involved in behavior and learning.

To reiterate, the in-beam null scanning approach presents at least the following two key distinctions over traditional superresolution techniques like MINFLUX:
1. Multiphoton excitation with longer wavelength light provides resolution enhancement and has enhanced penetration depths and is ideally suited for in vivo imaging at depth due to reduced scattering; and
2. A unique optical excitation scheme scans the dark vortex null in a spiral while keeping the excitation beam stable, which provides more accurate localization of a fluorophore at depth in inhomogeneous tissue because the stable beam does not sample different tissue paths like a scanned beam would.

Additional improvements to the presently described embodiments may be implemented using, for example, improved computational approaches to efficiently calculate the beam profile of microscopes within deep tissue, optimization of the excitation beam (e.g., by selection of the appropriate light source for a given use case scenario), motion tracking and correction therefor, and optimizing the labeling schemes for photo-activatable fluorophores for specific models, among others.

The data, information, and signals disclosed herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC.

Many embodiments and methods described herein may be realized using a processor in connection with processor executable instructions (also referred to as computer readable instructions) and a field programmable gate array programmed by hardware description language instructions. Nonvolatile memory may be encoded with instructions that are executable by a processor and/or are readable by a field programmable gate array, e.g., to program the field programmable gate array. In some embodiments, the FPGA is used for high-speed processing and control, including measurement, pulsing, and multi-level operation while a processor is utilized for other lower-speed processing.

As used herein, the recitation of “at least one of A, B and C” is intended to mean “either A, B, C or any combination of A, B and C.” The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The terms and expressions employed herein are used as terms and expressions of description and not of limitation, and there is no intention, in the use of such terms and expressions, of excluding any equivalents of the features shown and described or portions thereof. Each of the various elements disclosed herein may be achieved in a variety of manners. This disclosure should be understood to encompass each such variation, be it a variation of an embodiment of any apparatus embodiment, a method or process embodiment, or even merely a variation of any element of these. Particularly, it should be understood that the words for each element may be expressed by equivalent apparatus terms or method terms, even if only the function or result is the same. Such equivalent, broader, or even more generic terms should be considered to be encompassed in the description of each element or action. Such terms can be substituted where desired to make explicit the implicitly broad coverage to which this invention is entitled.

As but one example, it should be understood that all action may be expressed as a means for taking that action or as an element which causes that action. Similarly, each physical element disclosed should be understood to encompass a disclosure of the action which that physical element facilitates. Regarding this last aspect, by way of example only, the disclosure of a “protrusion” should be understood to encompass disclosure of the act of “protruding,” whether explicitly discussed or not, and, conversely, were there only disclosure of the act of “protruding,” such a disclosure should be understood to encompass disclosure of a “protrusion.” Such changes and alternative terms are to be understood to be explicitly included in the description.

What is claimed is:

1. A method for locating a position of a target within an object comprising:
imparting a beam of light on to an object to induce fluorescence from a target;
creating an intensity null in the beam;
moving the intensity null within the beam;
obtaining fluorescence data from the target as a function of a location of the intensity null; and
determining the location of the target based upon the data.

2. The method of claim 1, wherein moving the intensity null comprises moving the intensity null in a pattern within the beam to create a specific fluorescence response from the target over the path of the intensity null.

3. The method of claim 2, wherein moving the intensity null comprises moving the intensity null along a spiral path within the beam.

4. The method of claim 3, wherein the determining comprises moving the intensity null with constant azimuthal and radial rates away from a center of the spiral and identifying components of fluorescence data of the form:
$${I}_{n} ( {r}_{o} , {ϕ}_{o} ) = A ( {r}_{o}^{2} + {( {Δ}_{r} n )}^{2} - 2 {r}_{o} {Δ}_{r} n cos ( {ϕ}_{o} - {Δ}_{ϕ} n ) ) ,$$
where Δᵣ and Δ_{φ} are the radial and azimuthal step sizes of the intensity null along the spiral, n is the step number, A, is a scaling amplitude, and (rₒ, φₒ) are the polar coordinate location of the target relative to the center of the spiral.

5. The method of claim 4, wherein the identifying comprises curve fitting to the expression for Iₙ.

6. The method of claim 1, wherein the light is coherent light.

7. The method of claim 6, wherein creating the intensity null comprises creating the intensity null as an optical vortex.

8. The method of claim 7, wherein creating the intensity null as an optical vortex comprises creating and controlling the intensity null with a superposition of Laguerre Gaussian laser modes.

9. The method of claim 1 comprising:
moving the intensity null within the beam in connection with multiphoton excitation.

10. The method of claim 1 comprising maintaining the beam of coherent laser light stationery while moving the intensity null within the stationary beam.

11. The method of claim 1 comprising:
moving the beam of coherent laser light; and
moving the intensity null within the beam.

12. A system for locating a position of a target within an object, the system comprising:
a light source to impart a beam of light on to an object to induce fluorescence from a target;
a beam shaper configured to produce a moving intensity null within the beam;
a detector configured to detect fluorescence from a target within an object; and
processing logic configured to locate the target within the object based upon the detected fluorescence and the location of the intensity null.

13. The system of claim 12, wherein the light source comprises a laser configured to impart the beam of light as coherent light.

14. The system of claim 12, wherein the light source comprises an incoherent light source.

15. The system of claim 12, wherein the beam shaper comprises a spatial light modulator positioned between the light source and the object and configured to display holograms to produce the intensity null.

16. The system of claim 12, wherein the light source comprises a pulsed laser, and wherein the beam shaper comprises:
a beam splitter positioned and configured to split the beam into a first beam path and a second beam path;
a first spatial light modulator and a first acousto-optic modulator positioned in the first beam path, the first acousto-optic modulator configured to modulate an intensity of the first beam path;
a second spatial light modulator and a second acousto-optic modulator positioned in the second beam path, the second spatial light modulator configured to produce the intensity null in the second beam, and the second acousto-optic modulator configured to shift a frequency of the second beam; and
a combiner configured to combine the first and second beam to produce the moving intensity null within the beam.

17. The system of claim 16, wherein the first spatial light modulator and the second spatial light modulator are configured to operate without dynamically updating, and wherein the spiral motion results from interference of the frequency-shifted and intensity-modulated beams applied by the first and the second acousto-optic modulators.

18. The system of claim 17 comprising a controller to control the second acousto-optic modulator to control a frequency of the second beam to adjust an azimuthal radial position of the intensity null within the beam.

19. The system of claim 12 comprising a multiphoton microscope configured to utilize the moving intensity null within the beam induce fluorescence.

20. The system of claim 12, wherein the beam shaper is configured to move the intensity null along a spiral path within the beam.

21. The system of claim 12, wherein the processing logic is configured to control the beam shaper to move the intensity null with constant azimuthal and radial rates away from a center of a spiral and identify components of the data consistent with this expression:
$$A \{ {r}_{o}^{2} + {( {Δ}_{r} n )}^{2} - 2 {r}_{o} {Δ}_{r} n cos ( {ϕ}_{o} - {Δ}_{ϕ} n ) \}$$
where Δr and Δφ are the radial and azimuthal step sizes of the intensity null along the spiral, n is the step number, A, is a scaling amplitude, and (rₒ, φₒ) are the polar coordinate location of the target relative to the center of the spiral.
